(19) United States
(12) Patent Application Publication
(10) Pub. No.: US 2024/0058867 A1
(43) Pub. Date: Feb. 22, 2024

(54) PROCESS FOR PRODUCING A METALLIC STRUCTURE BY ADDITIVE MANUFACTURING

(71) Applicant: Commonweath Scientific and Industrial Research Organisation, Acton (AU)

(72) Inventors: Saden Heshmatollah ZAHIRI, Clayton (AU); Stefan GULIZIA, Clayton (AU)

(73) Assignee: Commonweath Scientific and Industrial Research Organisation, Acton (AU)

(21) Appl. No.: 18/259,200

(22) PCT Filed: Dec. 23, 2021
(86) PCT No.: PCT/AU2021/051551

§ 371 Date: Jun. 23, 2023

(30) Foreign Application Priority Data
Dec. 24, 2020 (AU) 2020904841

(51) Int. Cl. B22F 10/22; B22F 10/25; B33Y 10/00

(52) U.S. Cl. CPC B22F 10/22; B22F 10/25; B33Y 10/00; B22F 2005/005

(57) ABSTRACT

A process for producing a metallic structure by additive manufacturing comprises: providing a deposition-receptive substrate comprising a profiled surface, the profiled surface comprising a plurality of recessed and/or protruding surface features having elongated non-vertical walls and a depth of at least 0.5 mm relative to a base plane of the substrate; depositing metallic material on the substrate by an additive manufacturing technique to produce a first deposition layer which conforms to the profiled surface including the elongated non-vertical walls; and depositing successive deposition layers of the metallic material on the first deposition layer by the additive manufacturing technique to build up a metallic structure having a first thickness on the substrate, wherein each successive deposition layer conforms sufficiently to the profile of its preceding deposition layer to propagate a surface profile corresponding to the profiled surface of the substrate through the first thickness or a substantial portion thereof.

### TECHNICAL FIELD

The present invention generally relates to a process for producing a metallic structure by additive manufacturing, and to metallic structures produced by additive manufacturing on a substrate. The metallic structure is built up by depositing successive deposition layers of metallic material by an additive manufacturing technique onto a profiled substrate having surface features of significant depth, so that a surface profile corresponding to the profiled surface of the substrate is propagated through the metallic structure thickness or a substantial portion thereof. The invention is particularly applicable to the production of metallic structures by cold spray deposition, and it will be convenient to discuss aspects of the invention in relation to that exemplary technique. However, it should be appreciated that the invention is not specifically limited to cold spray deposition and extends to any additive manufacturing technique which is capable of building up metallic structures by depositing successive non-planar deposition layers of metallic material on a substrate.

### BACKGROUND OF INVENTION

Additive manufacturing techniques are increasingly favoured for the production of metallic components in industries such as aerospace, vehicle manufacture, marine, mining and construction. One method of directly manufacturing individually customisable metallic parts or products is through the use of cold spray technology. In cold spray processes, small metallic particles in the solid state are accelerated to high velocities (normally above 500 m/s) in a supersonic gas jet and deposited on a suitable substrate. The kinetic energy of the particles is utilised to achieve metallurgical bond formation between particles and mechanical interlocking of highly deformed particles (splats) that deposit under the supersonic shock load. Metallic structures of a desired configuration can thus be formed through progressive deposition of multiple layers using a desired spray pattern.

Cold spray technology has previously been proposed for additive manufacture and modification of large-scale metallic components, for example lay-up tools used to mould and cure fibre composite materials in the aerospace industry as disclosed in WO2014/028965.

A significant difficulty with cold spray manufacturing is the accumulation of residual stresses as the metallic structure is built up, both between the substrate and the deposited material and within the deposited material itself. The residual stress generally increases with each added deposition layer, so that an increase in thickness of the cold spray additive structure beyond a certain limit may cause a deformation stress force to overcome the bonding force between the cold spray deposit and the substrate. The metallic structure thus distorts and delaminates from the substrate. Alternatively, the residual stress accumulation within the metallic structure can lead to crack formation above a certain deposition thickness, or the substrate itself is deformed.

The risk of delamination is especially severe for large-dimension structures and in scenarios when the thermal properties of the substrate and the deposited metallic material are dissimilar. A high gas temperature may be used in cold spray processes to accelerate the particles to high velocities and to produce some thermal softening before impact, so that heat is inevitably transferred to the substrate and the deposited material. The residual stress between substrate and the deposited structure is thus particularly high when there is a large difference in the thermal expansion coefficients of the respective materials. Mitigation approaches such as pre-cooling the deposition surface or using cooling plates beneath the substrate have limited effects on the stress build-up for large-scale structures and introduce significant process complexity and cost.

Various attempts have been made to improve the bonding between cold spray deposits and substrate by roughening the substrate surface, for example by grit blasting, or by micro-texturing the substrate surface to improve interlocking of the cold sprayed particles with the substrate. While effective to a degree in improving the bond strength, this approach does little to disrupt the accumulated stresses in the initial deposition layers once the surface is filled. For thicker structures, particularly, the mechanical stresses in the deposit will accumulate regardless of the initial substrate microstructure, resulting in a high risk of delamination or cracking.

Another approach to produce thick metallic structures involves rotating the substrate during the cold spray deposition process, as disclosed in WO2015/157816. This mode of deposition may address delamination and cracking because the internal stresses in the metallic deposits are in compression, by contrast with the tensile stresses which dominate in conventional spray patterns. While useful for some applications where a round shape can be accommodated, the rotation approach is generally not suitable for many applications where larger-scale or non-round metallic structures are required.

While the above discussion has focused on cold spray deposition, similar difficulties can occur when producing metallic deposits of significant thickness via other additive manufacturing techniques which deposit successive deposition layers on a substrate.

There is therefore an ongoing need for processes for producing a metallic structure by additive manufacturing, which at least partially address one or more of the above-mentioned short-comings, or provide a useful alternative.

A reference herein to a patent document or other matter which is given as prior art is not to be taken as an admission that the document or matter was known or that the information it contains was part of the common general knowledge as at the priority date of any of the claims.

### SUMMARY OF INVENTION

In accordance with a first aspect the invention provides a process for producing a metallic structure by additive manufacturing, the process comprising: providing a deposition-receptive substrate comprising a profiled surface, the profiled surface comprising a plurality of recessed and/or protruding surface features having elongated non-vertical walls and a depth of at least 0.5 mm relative to a base plane of the substrate; depositing metallic material on the substrate by an additive manufacturing technique to produce a first deposition layer which conforms to the profiled surface including the elongated non-vertical walls; and depositing successive deposition layers of the metallic material on the first deposition layer by the additive manufacturing technique to build up a metallic structure having a first thickness on the substrate, wherein each successive deposition layer conforms sufficiently to the profile of its preceding deposition layer to propagate a surface profile corresponding to the profiled surface of the substrate through the first thickness or a substantial portion thereof.

The process of the invention uses a profiled substrate surface, comprising surface features with significant depth relative to the thickness of the deposition layers and the thickness of the structure to be built, to provide improved adhesion between a deposited metallic structure and its substrate, and improved cohesion within such deposited metallic structures. This reduces the risk of delamination and cracking, which may advantageously allow the production of thicker metallic structures and the production of metallic structures on thermally dissimilar substrates. The surface features may be, but are not limited to, V-shaped grooves or V-shaped ridges.

Without wishing to be limited by theory, it is believed that the accumulation of stresses across the initial continuous deposition layers conforming to the substrate is disrupted by the curvature over the substrate features. Moreover, because the surface features have a significant depth, the non-planar profile of the deposition layers propagates through a substantial thickness of the metallic structure, despite the gradual loss of resolution (or flattening) which inevitably occurs over many deposition layers in additive manufacturing. Thus, the accumulation of internal stresses through the bulk of the metallic structure is also disrupted, even in structures with thicknesses of 10 mm or higher.

In some embodiments of the first aspect, the metallic material is deposited by (i) selectively directing metallic particles or molten metal droplets from a metal applicator onto the substrate or the preceding deposition layer; or (ii) selectively irradiating metallic powder on the substrate or the preceding deposition layer with an energetic beam. The metallic material may be deposited by moving the metal applicator or energetic beam, relative to the profiled surface, in a direction which is substantially orthogonal to the elongated non-vertical walls. The metallic material may be deposited by moving the metal applicator or energetic beam, relative to the profiled surface, in a raster pattern across the substrate. The metallic material may be deposited by moving the metal applicator or energetic beam, relative to the profiled surface, along a plurality of continuous sweeps across the substrate, each continuous sweep traversing the plurality of recessed and/or protruding surface features and portions of the base plane between these surface features.

In some embodiments, the additive manufacturing technique is selected from the group consisting of cold spray deposition, direct metal laser melting (DMLM) and wire arc additive manufacturing (WAAM).

In some embodiments, the additive manufacturing technique is cold spray deposition.

In some embodiments, the metallic material is deposited by moving a cold spray applicator, relative to the profiled surface, in a spray direction which is substantially orthogonal)(90°±15° to the elongated non-vertical walls.

In some embodiments, the metallic material is deposited by moving a cold spray applicator, relative to the profiled surface, in a linear spray direction, for example in a raster pattern.

In some embodiments, the surface features have a depth of at least 1 mm, or at least 1.5 mm, such as at least 2 mm, relative to the base plane of the substrate.

In some embodiments, the surface profile corresponding to the profiled surface of the substrate progressively flattens as the successive deposition layers of the metallic material are deposited

In some embodiments, the surface profile corresponding to the profiled surface of the substrate is propagated through the entire first thickness or at least 5 mm thereof. In some embodiments, the surface profile corresponding to the profiled surface of the substrate is propagated through the entire first thickness or at least 10 mm thereof.

In some embodiments, the surface profile corresponding to the profiled surface of the substrate is propagated through at least 5 mm, or at least 10 mm, of the first thickness. In some embodiments, the surface profile corresponding to the profiled surface of the substrate is propagated through the entire first thickness of the metallic structure. In other embodiments, the surface profile corresponding to the profiled surface of the substrate is propagated through a substantial proportion of the total first thickness of the metallic structure, for example at least 50%, or at least 60%, or at least 70%, or at least 80%, or at least 90%.

In some embodiments, the surface profile corresponding to the profiled surface of the substrate is propagated only partway through the first thickness of the metallic structure such that a top surface of the metallic structure, defined by an outermost deposition layer, is substantially flat.

In some embodiments, the substrate and the metallic material have different coefficients of thermal expansion. The substrate and the metallic material may have coefficients of thermal expansion which differ (subtractively) by more than 5×10⁻⁶ mm/(mm.° C.), or by more than 10×10⁻⁶ mm/(mm.° C.), or by more than 15×10⁻⁶ mm/(mm.° C.).

In some embodiments, the elongated non-vertical walls are inclined at an angle of between 110° and 155°, such as between 120° and 135°, relative to the base plane of the substrate.

In some embodiments, the surface features comprise at least one selected from grooves, ridges and inclined steps. In some embodiments, the surface features comprise at least one selected from V-shaped grooves, V-shaped ridges and inclined steps. In some embodiments, the profiled surface comprises a plurality of V-shaped grooves and/or V-shaped ridges.

In some embodiments, the elongated non-vertical walls of adjacent surface features are spaced apart by a distance across the base plane of the substrate of between 3 mm and 20 mm, such as between 5 and 15 mm.

In some embodiments, the elongated non-vertical walls of adjacent surface features are parallel, and optionally uniformly spaced apart, in the plane of the substrate. In some embodiments, the elongated non-vertical walls are linear in the plane of the substrate.

In some embodiments, the metallic material comprises a nickel-iron alloy, for example Invar 36.

In some embodiments, the substrate is a metallic substrate.

In some embodiments, the first thickness is at least 5 mm, or at least 10 mm, or at least 15 mm. In some embodiments, the metallic structure has at least one dimension, along the plane of the substrate, of greater 100 mm, or greater than 500 mm, or greater than 1000 mm. This dimension may be orthogonal to the elongated non-vertical walls and/or in the cold spray deposition direction.

In some embodiments, the plurality of recessed and/or protruding surface features are produced in the substrate by machining. In other embodiments, the plurality of recessed and/or protruding surface features are produced on the substrate by cold spray deposition.

In some embodiments, the process further comprises: forming a plurality of recessed and/or protruding top surface features in a top surface of the metallic structure, the top surface features having elongated non-vertical walls; depositing metallic material on the top surface of the metallic structure by cold spray deposition to produce a further deposition layer which conforms to the top surface including the elongated non-vertical walls; and depositing successive deposition layers of the metallic material on the further deposition layer by cold spray deposition to extend the thickness of the metallic structure to a second thickness.

In some embodiments, the top surface features have a depth of at least 0.5 mm, or at least 1 mm, or at least 1.5 mm, or at least 2 mm.

In some embodiments, the top surface features are formed in the top surface of the metallic structure by machining.

In some embodiments, the plurality of recessed and/or protruding surface features are produced on the substrate by the additive manufacturing technique before producing the first deposition layer.

In accordance with a second aspect the invention provides a metallic structure produced by additive manufacturing on a substrate comprising a profiled surface comprising a plurality of recessed and/or protruding surface features having elongated non-vertical walls and a depth of at least 0.5 mm relative to a base plane of the substrate, the metallic structure comprising: a first deposition layer comprising metallic material deposited on the substrate, wherein the first deposition layer conforms to the profiled surface of the substrate including the elongated non-vertical walls; and successive deposition layers comprising the metallic material deposited on the first deposition layer to form the metallic structure with a first thickness, wherein each successive deposition layer conforms sufficiently to the profile of its preceding deposition layer to propagate a surface profile corresponding to the profiled surface of the substrate through the first thickness or a substantial portion thereof.

In some embodiments of the second aspect, the metallic material is deposited by an additive manufacturing technique selected from the group consisting of cold spray deposition, direct metal laser melting (DMLM) and wire arc additive manufacturing (WAAM).

In some embodiments, the metallic material is deposited by cold spray deposition in a spray direction which is substantially orthogonal to the elongated non-vertical walls of the substrate.

In some embodiments, the surface features of the substrate have a depth of at least 1 mm, or at least 1.5 mm, or at least 2 mm, relative to the base plane of the substrate.

In some embodiments, the surface profile corresponding to the profiled surface of the substrate is propagated through the entire first thickness or at least 5 mm thereof. In some embodiments, the surface profile corresponding to the profiled surface of the substrate is propagated through the entire first thickness or at least 10 mm thereof.

In some embodiments, the surface profile corresponding to the profiled surface of the substrate is propagated through at least 5 mm, or at least 10 mm, of the first thickness. In some embodiments, a surface profile corresponding to the profiled surface of the substrate is propagated through the entire first thickness of the metallic structure. In other embodiments, a surface profile corresponding to the profiled surface of the substrate is propagated through a substantial proportion of the total thickness of the metallic structure, for example at least 50%, or at least 60%, or at least 70%, or at least 80%, or at least 90%.

In some embodiments, the surface profile corresponding to the profiled surface of the substrate is propagated only partway through the first thickness of the metallic structure such that a top surface of the metallic structure, defined by an outermost deposition layer, is substantially flat.

In some embodiments, the substrate and the metallic material have different coefficients of thermal expansion.

In some embodiments, the elongated non-vertical walls are inclined at an angle of between 110° and 155°, such as between 120° and 135°, relative to the base plane of the substrate.

In some embodiments, the surface features comprise at least one selected from grooves, ridges and inclined steps. In some embodiments, the surface features comprise at least one selected from V-shaped grooves, V-shaped ridges and inclined steps.

In some embodiments, the elongated non-vertical walls of adjacent surface features are spaced apart by a distance across the base plane of the substrate of between 3 mm and 20 mm, such as between 5 and 15 mm.

In some embodiments, the metallic material comprises a nickel-iron alloy, for example Invar 36.

In some embodiments, the first thickness is at least 5 mm, or at least 10 mm. In some embodiments, the metallic structure has at least one dimension, along the plane of the substrate, of greater than 100 mm, or 500 mm, or 1000 mm. This dimension may be orthogonal to the elongated non-vertical walls of the substrate and/or in the cold spray deposition direction.

In some embodiments, the metallic structure remains on the substrate. In other embodiments, the metallic structure is separated from the substrate.

In accordance with a third aspect the invention provides a metallic structure, produced by a process according to any embodiment of the first aspect.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

As used herein, the terms “first”, “second”, “third” etc in relation to various features of the disclosed devices are arbitrarily assigned and are merely intended to differentiate between two or more such features that the device may incorporate in various embodiments. The terms do not of themselves indicate any particular orientation or sequence. Moreover, it is to be understood that the presence of a “first” feature does not imply that a “second” feature is present, the presence of a “second” feature does not imply that a “first” feature is present, etc.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 schematically depicts a prior art process for producing a metallic structure by cold spray deposition on a planar substrate.

FIG. 2 schematically depicts a prior art process for producing a metallic structure by cold spray deposition on a planar substrate, wherein the metallic structure has delaminated from the substrate and cracked due to an accumulation of stresses.

FIG. 3 schematically depicts a metallic structure produced by cold spray deposition on a profiled substrate according to embodiments of the invention.

FIG. 4 depicts in plan view a profiled metallic plate substrate comprising a plurality of parallel and uniformly spaced elongated V-shaped grooves, on which a metallic structure may be produced by cold spray deposition according to embodiments of the invention.

FIG. 5 schematically depicts the profiled metallic plate substrate of FIG. 4 in a side cross-sectional view.

FIG. 6 schematically depicts the deposition of metallic material by a cold spray applicator in a first deposition layer on the profiled metallic plate substrate of FIG. 5, according to an embodiment of the invention.

FIG. 7 schematically depicts a metallic structure produced by deposition of metallic material on the first deposition layer of FIG. 6 by successive cold sprayed deposition layers, according to an embodiment of the invention.

FIG. 8 schematically depicts a metallic structure produced by deposition of metallic material on the first deposition layer of FIG. 6 by successive cold sprayed deposition layers, wherein a profiled surface is propagated through the entire thickness of the metallic structure according to an embodiment of the invention.

FIG. 9 schematically depicts a metallic structure produced by deposition of metallic material on the first deposition layer of FIG. 6 by successive cold sprayed deposition layers, wherein a profiled surface is propagated through a substantial proportion of the thickness of the metallic structure according to an embodiment of the invention.

FIG. 10 schematically depicts in side cross-section view a metallic structure produced by deposition of metallic material on a profiled substrate comprising a plurality of parallel and uniformly spaced elongated V-shaped ridges, by successive cold sprayed deposition layers according to an embodiment of the invention.

FIG. 11 schematically depicts in side cross-section view a metallic structure produced by deposition of metallic material on a profiled substrate comprising a plurality of parallel and uniformly spaced elongated inclined steps, by successive cold sprayed deposition layers according to an embodiment of the invention.

FIG. 12 schematically depicts in side cross-section view the metallic structure of FIG. 9, after machining a plurality of parallel and uniformly spaced elongated V-shaped grooves in the top surface according to an embodiment of the invention.

FIG. 13 schematically depicts an extended metallic structure produced by deposition of metallic material on the metallic structure of FIG. 12 by successive cold sprayed deposition layers according to an embodiment of the invention.

FIG. 14 is a photograph of a delaminated Invar 36 structure produced on a planar aluminium substrate in Example 1.

FIG. 15 is a photograph of an Invar 36 structure produced on a profiled aluminium substrate having a plurality of 1 mm deep, 90° grooves, according to an embodiment of the invention in Example 2.

FIG. 16 is a photograph of an Invar 36 structure produced on a profiled aluminium substrate having a plurality of 1 mm deep, 60° grooves, according to an embodiment of the invention in Example 3.

FIG. 17 is another photograph of the Invar 36 structure produced on a profiled aluminium substrate having a plurality of 1 mm deep, 60° grooves in Example 3.

FIG. 18 is a photograph of an Invar 36 structure produced on a profiled aluminium substrate having a plurality of 2 mm deep, 90° grooves, according to an embodiment of the invention in Example 4.

FIG. 19 schematically depicts in top view a vertically mounted, mild steel planar substrate ready to receive cold sprayed CP Ti, as used in Examples 5 and 6.

FIG. 20 schematically depicts the planar substrate of FIG. 19, onto which four approximately V-shaped ridges, each having a vertical orientation, were cold sprayed with CP Ti in Example 6, thereby producing a profiled surface on the substrate.

FIG. 21 schematically depicts a cold sprayed CP Ti structure produced on the profiled surface depicted in FIG. 20 by depositing successive CP Ti deposition layers via cold spray in Example 6.

### DETAILED DESCRIPTION

### Process

The present invention relates to a process for producing a metallic structure by an additive manufacturing technique, such as cold spray deposition. The process comprises providing a deposition-receptive substrate comprising a profiled surface, the profiled surface comprising a plurality of recessed and/or protruding surface features having elongated non-vertical walls and a depth of at least 0.5 mm relative to a base plane of the substrate. Metallic material is deposited on the substrate by an additive manufacturing technique, such as cold spray deposition, to produce a first deposition layer which conforms to the profiled surface including the elongated non-vertical walls. The first deposition layer thus overlies, and adopts the profiled shape of, the profiled substrate as defined by the base plane of the substrate and the plurality of surface features which are recessed into or protrude from the base plane. Successive deposition layers of the metallic material are then deposited on the first deposition layer by cold spray deposition to build up a metallic structure on the substrate. Each successive deposition layer conforms sufficiently to the profile of its preceding deposition layer to propagate a surface profile corresponding to the profiled surface of the substrate through the thickness of the metallic structure or a substantial portion thereof.

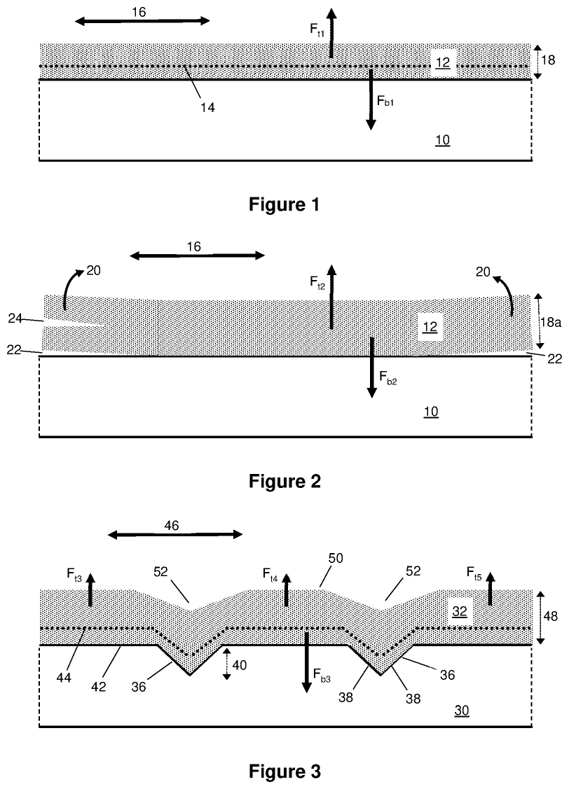

FIGS. 1 and 2 schematically depict typical results of a conventional process for producing a metallic structure by cold spray deposition on a planar substrate, particularly for a scenario where the materials of the substrate and metallic structure have significantly different coefficients of thermal expansion. Metallic structure 12 is built up by depositing a series of successive planar deposition layers (deposition layer 14 depicted, at arbitrary thickness) on planar substrate 10. The deposition layers are typically deposited in a single deposition direction 16, for example by linearly scanning a cold sprayed stream of particles back and forth across the substrate (a raster pattern). At relatively low total thickness 18, as seen in FIG. 1, the bonding forces, between metallic structure 12 and substrate 10 and within metallic structure 12 as represented by arrow F_{b1}, exceed the stresses which accumulate in the metallic structure, represented by arrow Fₜ₁. Metallic structure 12 thus remains bonded to substrate 12 and retains its physical integrity.

After further cold spray deposition to an increased thickness 18a, as seen in FIG. 2, the bonding forces F_{b2} between metallic structure 12 and substrate 10 and within metallic structure 12 are overcome by the torsional stresses Fₜ₂ which accumulate in the metallic structure, primarily in the deposition direction 16. Metallic structure 12 thus distorts in the direction of arrows 20, particularly at the edges, delaminating metallic structure 12 from substrate 10 (interface cracks 22) and/or cracking the metallic structure (metallic structure crack 24).

FIG. 3 schematically depicts the results of a process for producing a metallic structure by cold spray deposition (as an exemplary additive manufacturing technique) on a profiled substrate according to an embodiment of the present invention. Substrate 30 comprises a profiled surface having a plurality of recessed surface features 36 with elongated non-vertical walls 38 and a depth 40 of at least 0.5 mm relative to base plane 42 of the substrate. In the depicted embodiment, features 36 are linear, parallel V-shaped grooves, so that non-vertical walls 38 are elongated in the plane of the substrate in a direction normal to (into) the cross-sectional view of FIG. 3.

Metallic structure 32 is built up by depositing a series of successive deposition layers (deposition layer 44 depicted, at arbitrary thickness) on profiled substrate 30. The deposition layers are deposited in a single deposition direction 46, e.g. in a raster pattern, which is preferably substantially orthogonal to the elongated non-vertical groove walls 38. Each successive deposition layer conforms sufficiently to the profile of its preceding deposition layer to propagate a surface profile corresponding to the profiled surface of the substrate through a substantial thickness of the metallic structure. In the depicted embodiment, a surface profile 50 comprising grooves 52 is propagated through the entire thickness 48 of metallic structure 32 (which may be at least the same thickness as thickness 18a of FIG. 2). Thus, each deposition layer in the metallic structure (including depicted deposition layer 44) adopts a profiled shape which corresponds to that of the substrate.

Without wishing to be bound by any theory, it is proposed that this curvature of the deposition layers disrupts the accumulation of stresses in metallic structure 32, particularly in the deposition direction. The bonding forces between metallic structure 32 and substrate 30 and within metallic structure 32, as represented by arrow F_{b3}, are expected to be similar to bonding forces F_{b2} for a conventional cold spray scenario. However, the torsional stresses which accumulate in the metallic structure, primarily in the deposition direction 46, are now disrupted by the propagated profile of each deposition layer, and may thus be considered divided into smaller separate forces Fₜ₃, Fₜ₄ and Fₜ₅. The combined effect of these forces is insufficient to overcome bonding forces F_{b3}, so that metallic structure 32 remains bonded to substrate 32 and retains its physical integrity. This improvement may be obtained despite a very significant thickness 48 of the metallic structure and/or when the materials of the substrate and metallic structure have significantly different coefficients of thermal expansion.

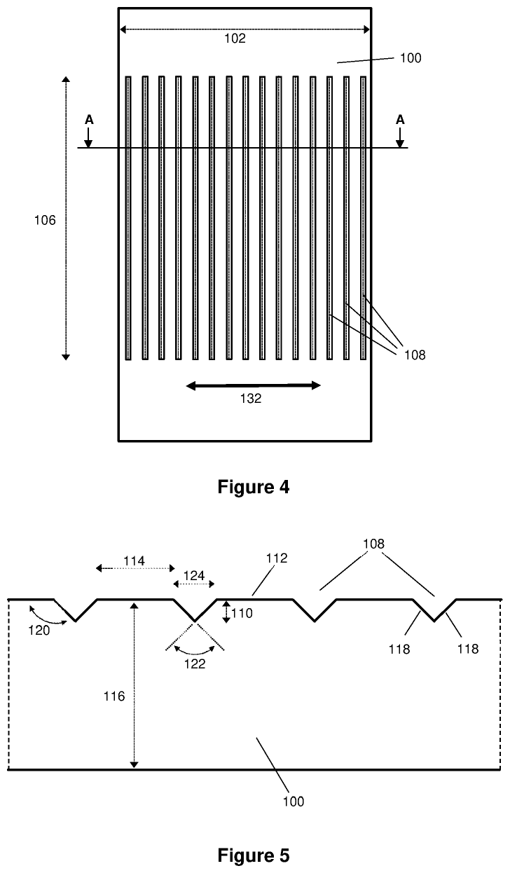

Embodiments of the invention will now be described in greater detail with reference to FIGS. 4 to 9. FIG. 4 depicts in plan view a metallic plate substrate 100 having width 102 and comprising a plurality of parallel and uniformly spaced elongated V-shaped grooves 108 formed in the otherwise planar substrate surface. Fifteen such grooves arranged across the full width of the substrate are shown in this exemplary embodiment, but it will be appreciated that more or fewer grooves may be used depending on factors such as the size and thickness of the structure to be produced. The grooves have a length 106 which is likely to be determined by the dimensions of the structure to be deposited. In some embodiments, the grooves are longer than the structure to be produced.

FIG. 5 depicts a side cross-sectional view of substrate 100 through part of section A-A shown in FIG. 4. V-shaped grooves 108 have a depth 110, normal to base plane 112 of the substrate, of at least about 0.5 mm, for example in the range of 1 mm to 3 mm. Grooves 108 are spaced apart across the base plane of the substrate by groove spacing 114, which in some embodiments is a distance of between 3 mm and 20 mm, for example between 5 and 15 mm. The groove depth and groove spacing are important parameters which can be selected based on factors including but not limited to the desired thickness of the metallic structure to be produced and the choice of the substrate and cold sprayed materials. Typically, groove depth 110 is small by comparison to the substrate thickness 116 so that the structural integrity of the substrate is not affected.

V-shaped grooves 108 are defined by side walls 118 which are elongated in the plane of the substrate along length 106 of the grooves, and inclined at an angle 120 relative to the base plane of the substrate. Because a first deposition layer of cold sprayed metallic material should conform to the profiled surface of substrate 100, side walls 118 are non-vertical and angle 120 is sufficiently greater than 90° to allow adhesion of cold-sprayed metallic particles which impact the side walls. In some embodiments, angle 120 is greater than 110°, or between 110° and 155°, for example between about 120° and about 135°, relative to base plane 112 of the substrate. Correspondingly, groove angle 122 between the sidewalls may be greater than 40°, or between 40° and 130°, for example between about 60° and about 90°. Groove width 124 is typically a determined parameter set by the groove depths and angles.

Due to their significant depth and width, and their non-vertical side walls which are configured to receive a conforming deposition layer of cold sprayed particles, grooves 108 are distinguished from rectangular (vertical-walled) microgrooves which have previously been used to facilitate adhesion of cold spray deposits to a substrate by particle interlocking mechanisms.

In the exemplary embodiment here described, grooves 108 are linear, parallel and uniformly spaced apart on the substrate surface, and V-shaped and uniform in cross-sectional profile. While this arrangement is convenient and shown to provide satisfactory results, it will be appreciated that such groove configurations are not essential to achieve all advantages of the invention. A variety of groove shapes, including grooves having curved and other non-linear shapes in the substrate plane, grooves having a variety of cross-sectional profiles, including curved-wall grooves, and non-repeating groove configurations may be suitable, for example to disrupt the accumulated stresses between the substrate and metallic structure or within the metallic structure itself. In this context, it should be understood that elongated non-vertical walls of grooves (or other suitable surface features disclosed herein) are elongated in the plane of the substrate by comparison with their depth into the substrate. Thus, grooves which are curved in the plane of the substrate may also have elongated walls. As will be discussed hereafter, profiled substrates having surface features other than grooves may also suitably be employed.

Grooves 108 may be provided on the surface of substrate 100 by any suitable means, including by machining or other subtractive techniques starting from a pre-existing substrate, manufacturing a grooved substrate directly, for example by casting or moulding, or by additively producing grooved features on a substrate surface, including by cold-spray manufacturing techniques. In some embodiments, the grooves are precision-machined into a planar metallic substrate.

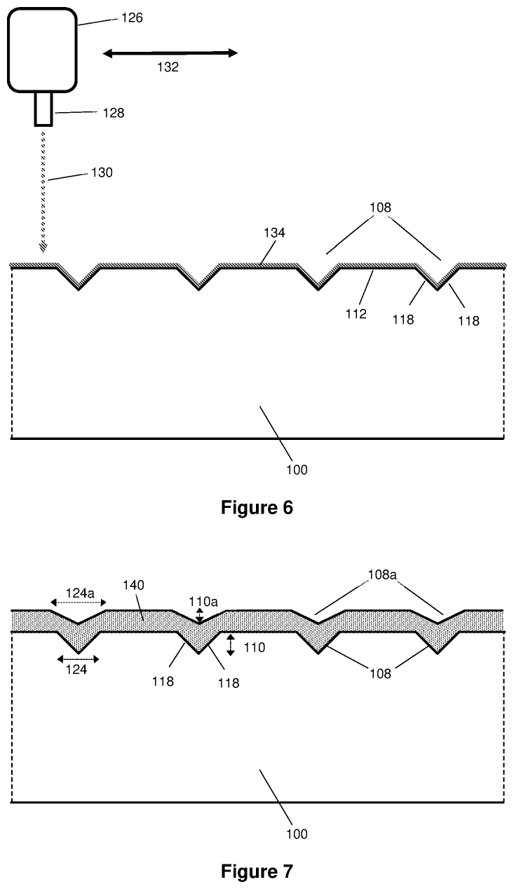

To build the metallic structure, a cold spray applicator 126 comprising spray nozzle 128 (as an exemplary additive manufacturing apparatus) is arranged relative to substrate 100 to allow a desired metallic material to be deposited onto the profiled substrate surface, for example as seen in FIG. 6. In some embodiments, as seen in plan (top) view in FIG. 6, substrate 100 is mounted in a stationary, vertical orientation, for example with grooves 108 extending vertically. Nozzle 128 of cold spray applicator 126 is then oriented to direct spray stream 130 of particulate metallic material horizontally onto the substrate surface. Cold spray applicator 126 may be mounted on a robotic arm capable of moving in three dimensions relative to the stationary substrate, and is thus configured to traverse spray stream 130 horizontally along two axes in the plane of the substrate and to move toward or away from the substrate along the third axis, for example to maintain a constant stand-off distance as the metallic structure is built. However, it will be appreciated that other arrangements may be suitable to control the movement of a cold spray applicator relative to the substrate surface. For example, the cold spray applicator may be moved by a linear actuator to traverse the substrate along one axis while the substrate is moved in the direction of the second axis. In another example, the cold spray applicator is stationary while the substrate is moved.

Cold spray applicator 126 may be moved, relative to substrate 100, to produce a linear spray path 132 of spray stream 130 across the substrate surface. In some such embodiments, the cold spray deposition process uses a raster deposition pattern, meaning that each deposition layer is produced by linearly scanning spray stream 130 back and forth in continuous sweeps across the substrate, while displacing each successive linear spray path incrementally so that an even and continuous layer is produced. A raster pattern is advantageous for many applications due to the relative simplicity of robot programming required. Typically, each deposition layer is completed before the next deposition layer is deposited thereon via a similar raster pattern. In this manner, a metallic structure of desired thickness can be constructed.

Cold spray applicator 126 may be moved, relative to substrate 100, to deposit the metallic material in a spray direction 132 which is substantially orthogonal (i.e. 90°±15°) to grooves 108 and in particular their elongated side walls 118. It has been found that the stresses in a cold sprayed metallic structure deposited by linear deposition techniques (e.g. via a raster pattern) accumulate primarily in the deposition direction. Thus, it is considered particularly beneficial if the grooves are arranged orthogonally to the deposition direction to disrupt these stresses. Without wishing to be bound by any theory, it is believed that the stresses accumulating in the cold sprayed metallic structure are disrupted by the curvature of each deposition layer into and out of the groove near the substrate, or along the corresponding non-planar surface topology which propagates through the thickness of the structure. While orthogonal spray motion relative to the groove walls is thus a particularly desirable scenario, it will be appreciated that stresses within the metallic structure may beneficially be disrupted to at least an extent with other spray directions, for example diagonally across the grooves or even parallel to the grooves.

As depicted in FIG. 6, cold spray applicator 126 is moved, relative to substrate 100 and orthogonally to grooves 108, in a raster pattern to deposit a first deposition layer 134 of metallic material on profiled substrate 100. First deposition layer 134 is a continuous layer which conforms to the profiled surface, including both the elongated non-vertical walls 118 of grooves 108 and the intermediate base plane regions 112. Typically, but not necessarily, first deposition layer 134 is completed across the full footprint of the metallic structure to be constructed before the next deposition layer is deposited thereon.

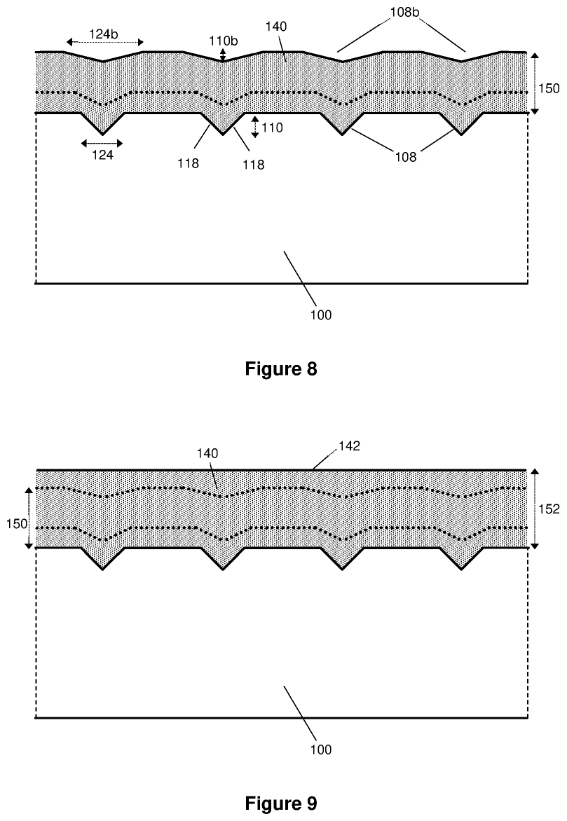

Once first deposition layer 134 is laid down, successive deposition layers are deposited on the first deposition layer by cold spray deposition, typically using the same raster pattern. Metallic structure 140 is thus built up on the substrate to a desired thickness, as seen in FIGS. 7, 8 and 9. Because each deposition layer conforms closely to the profile of the preceding deposition layer on which it is deposited, a surface profile corresponding to the profiled surface of the substrate propagates through the thickness of the metallic structure as it is built. The cold spray process inevitably results in a flattening, or loss of resolution, with each successive deposition layer. This is schematically depicted in FIGS. 7 and 8, which show the configuration of metallic structure 140 at two arbitrary stages as the structure thickness increases. In FIG. 7, the deposition surface retains a non-planar profile having grooves 108a which correspond to grooves 108 in the substrate. However, due to the flattening effect, grooves 108a have a depth 110a which is less than depth 110 of substrate grooves 108 and a groove width 124a which is greater than groove width 124 of substrate grooves 108. In FIG. 8, this trend continues with shallow grooves or depressions 108b now having a further reduced depth 110b and increased width 124b, and typically also a more rounded cross-sectional groove profile.

Despite the progressive flattening of the surface, the initial configuration of the substrate grooves 108, in particular their significant depth, results in the propagation of a non-planar surface profile through a very substantial thickness 150 of the metallic structure. This is believed to cause ongoing disruption of the stresses accumulating in the metallic structure, so that thicker structures can be built with reduced risk of delamination or cracking. Depending on the substrate groove dimensions, a surface profile having non-planar features corresponding to those of the substrate can be propagated through a thickness of at least 5 mm, or at least 10 mm, or at least 15 mm, or more.

In some embodiments, the profiled surface is propagated through the entire thickness of the metallic structure (at least across part of its breadth). This is achieved, for example, if cold spray deposition is terminated at the stage depicted in FIG. 8. Alternatively, as depicted in FIG. 9, cold spray deposition may be continued via the addition of further deposition layers until the top surface 142 of metallic structure 140 is substantially flat, and even for a limited additional thickness thereafter. It will be appreciated, however, that disruption of the deposition stresses may decrease as the deposition surface becomes progressively flatter, and negligible stress disruption is provided within the metallic structure in planar deposition layers laid down after complete loss of the surface resolution. Thus, it is preferred that a surface profile corresponding to the substrate surface is propagated to a thickness 150 of at least 5 mm, or at least 10 mm, or at least 15 mm and/or which forms a substantial proportion of the total thickness 152 of the cold-spray deposited metallic structure, for example at least 50%, at least 60%, at least 70%, at least 80% or at least 90%.

Evidence of surface profile propagation via successive deposition layers through the thickness of a cold-sprayed metallic structure may be evident in the final manufactured article. In at least some cases, it is visually apparent when viewed from the side or in a cross-section cut through the article. Moreover, microstructural characterisation techniques such as metallography and X-ray analysis may be used identify the way in which particles were deposited in the bulk material.

### Substrate

The process disclosed herein comprises a step of providing a deposition-receptive substrate with a profiled surface. The substrate may be made of any material or combination of materials which can be shaped to provide a profiled surface which is suitable to receive and adhere a deposition layer of metal particles, e.g cold-sprayed particles, or molten metal (i.e. the substrate is deposition-receptive) and on which a metallic structure can thus be built by cold spray deposition. In some embodiments, the substrate is metallic including metal alloys and metal composites. However non-metallic substrates, such as ceramic substrates, are also envisaged and fall within the scope of the invention. In some embodiments, the substrate comprises a metal selected from aluminium, copper, steel and titanium.

The surface microstructure (e.g. roughness, micro-textured features) of the substrate may influence the adhesion between metallic structure and substrate as well as the characteristics of the corresponding surface of the metallic structure at the substrate-structure interface. In some embodiments, the surface is roughened, for example by grit-blasting, to improve adhesion. It is also envisaged that the surface may be micro-textured with surface features have substantially smaller dimensions than the surface features with a depth of at least 0.5 mm. Such micro-texturing may facilitate mechanical interlocking of cold-spray deposited surface particles in the initial deposition layers with the substrate. Desirably, the deposition-receptive substrate surface is free of defects (e.g., scratches, dents, pits, voids, pinholes, inclusions, markings etc.) so that the metallic structure interface is correspondingly defect-free.

The profiled surface comprises a plurality of recessed and/or protruding surface features having elongated non-vertical walls and a depth of at least 0.5 mm relative to a base plane of the substrate. As used herein, the depth of a recessed or protruding feature refers to its elevation into or out of the surface, relative to a base plane of the substrate. The base plane refers to the main portion of the substrate surface between the surface features and which represents the overall contour of the substrate into which (or from which) the surface features are recessed (or protrude). In some embodiments, the base plane is flat (planar), but it is not excluded that the overall substrate surface, and thus the base plane thereof, may be curved.

According to the principles disclosed herein, one proposed role of the surface features is to cause significant non-planarity, or deviation from the base plane contour, in the deposition layers produced by additive manufacturing, including the first and immediately following deposition layers which conform closely to the shape of the profiled substrate surface and also those further removed deposition layers which nevertheless adopted a contoured configuration due to the propagation of the surface profile through the metallic structure. As the skilled person will appreciate, surface features with a variety of configurations are capable of fulfilling this function and are within the scope of the invention.

In some embodiments, the surface features comprise at least one selected from grooves, ridges and inclined steps. The non-vertical walls of these features may optionally be substantially planar, so that the grooves and ridges are V-shaped in cross-sectional profile. However, it will be appreciated that curved walls are also suitable provided that they remain receptive to metallic deposition, for example by cold sprayed particles.

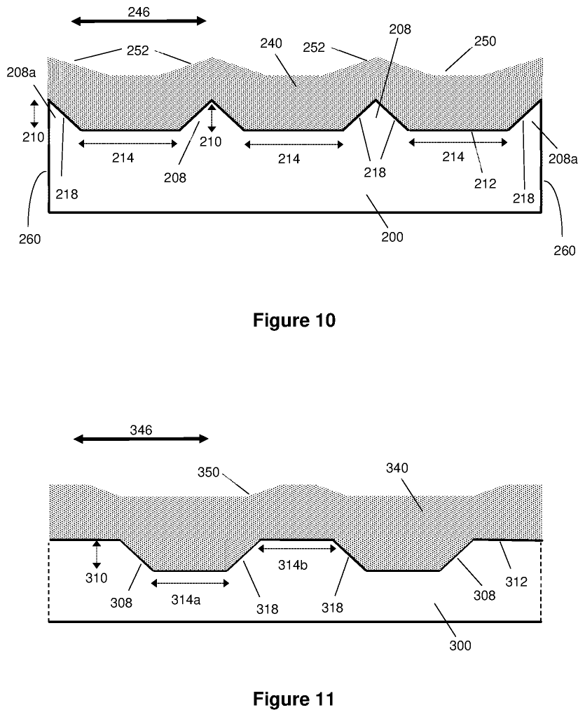

Depicted in FIG. 10 is a profiled substrate 200 on which metallic structure 240 has been produced according to an exemplary embodiment of the invention. Substrate 200 comprises a profiled surface having a plurality of protruding surface features including ridges 208 and 208a with elongated non-vertical walls 218 and a depth 210 of at least 0.5 mm relative to base plane 212 of the substrate. Ridges 208 are V-shaped ridges in the middle of the profiled surface while ridges 208a are formed at and aligned with edges 260 of substrate 200. Alternatively, ridges 208a may also be V-shaped ridges which are proximate to edges 260. In the depicted embodiment, ridges 208 are linear, parallel ridges, so that non-vertical walls 218 are elongated in the plane of the substrate in a direction normal to (into) the cross-sectional view of FIG. 10. Ridges 208, 208a are spaced apart across the base plane of the substrate by ridge spacing 214, which in some embodiments is a distance of between 3 mm and 20 mm, for example between 5 and 15 mm. In some embodiments, ridges 208, 208a are formed by cold spray deposition (or another suitable additive manufacturing technique), which may be the same deposition technique used to build up the metallic structure.

Metallic structure 240 is built up by depositing successive deposition layers on substrate 200 by cold spray (as an exemplary additive manufacturing technique). The deposition layers may be deposited in a single deposition direction 246, e.g. in a raster pattern, which is preferably substantially orthogonal to the elongated non-vertical ridge walls 218. Each successive deposition layer conforms sufficiently to the profile of its preceding deposition layer to propagate a surface profile corresponding to the profiled surface of the substrate through a substantial thickness of the metallic structure. In the depicted embodiment, a surface profile 250 comprising ridges 252 is propagated through the entire thickness of metallic structure 240. Ridges 252 at the top surface may be shallower, broader and more rounded than the corresponding substrate ridges 208, due to the flattening effect. In other embodiments, deposition may be continued to a thickness at which the top surface becomes substantially flat. In this case, a ridged surface profile may be propagated through a thickness of at least 5 mm, or at least 10 mm, or at least 15 mm and/or which forms a substantial proportion of the total thickness of metallic structure 240, for example at least 50%, at least 60%, at least 70%, at least 80% or at least 90%.

Ridges 208a, located close to or at the substrate edges, are considered particularly useful as they introduce non-planarity into the deposition layers at the location where the maximum thermal gradient is expected and where cracks in the deposited structure are most likely to form. Ridges 208 may be useful to further disrupt the planarity of the deposition layers in the regions between the edges, but it will be appreciated that intermediate surface features are not required in all embodiments, for example where substrate 200 is relatively small or where defects in the deposit are only expected at the edges.

Depicted in FIG. 11 is a profiled substrate 300 on which metallic structure 340 has been produced according to another exemplary embodiment of the invention. Substrate 300 comprises a profiled (corrugated) surface having a plurality of recessed inclined steps 308 with elongated non-vertical walls 318 and a depth 310 of at least 0.5 mm relative to base plane 312 of the substrate. In the depicted embodiment, steps 308 are linear and parallel, so that non-vertical walls 318 are elongated in the plane of the substrate in a direction normal to (into) the cross-sectional view of FIG. 11. Step walls 318 are spaced apart across the base plane of the substrate by interwall spacings 314a and 314b, which in some embodiments are a distance of between 3 mm and 20 mm, for example between 5 and 15 mm.

Metallic structure 340 is built up by depositing a series of successive deposition layers on substrate 300, for example in a raster pattern along deposition direction 346 which is substantially orthogonal to the elongated non-vertical step walls 318. Each successive deposition layer conforms sufficiently to the profile of its preceding deposition layer to propagate a surface profile 350 corresponding to the step-profiled surface of the substrate through a substantial thickness of the metallic structure.

Regardless of their specific configuration, the surface features of the profiled substrate have a significant depth in order that a surface profile is propagated through a substantial thickness of the metallic structure. In some embodiments, this depth is at least 1 mm, or at least 1.5 mm, or at least 2 mm, relative to the base plane of the substrate. The inventors have demonstrated that depths of 1 mm or 2 mm may be used to propagate a surface profile through a metallic structure thickness of greater than 10 mm. It will be appreciated that the depth of the surface features may be selected based on considerations such as the desired thickness of the metallic structure, the thickness of each deposition layer, the composition of the metallic structure, the compatibility between the materials of the metallic structure and the substrate, and the additive manufacturing technique.

The elongated non-vertical walls of the surface features may be inclined at an angle of between 110° and 155°, or between 120° and 135°, relative to the base plane of the substrate. In these ranges, the walls may be sufficiently inclined (i.e. sufficiently greater than 90°) to receive and adhere metallic particles or molten metal, e.g. cold sprayed particles delivered normally to the substrate, but sufficiently angled (i.e. sufficiently less than 180°) to produce significant non-planarity in the deposition layers and thus disrupt the stresses accumulating in the metallic deposits. As noted, the walls are not required to be planar, and may be curved, so that the walls may adopt multiple angles in these ranges.

It will be appreciated that the angled intersection between the elongated non-vertical walls and the base plane or between two adjacent elongated non-vertical walls (e.g. forming a groove or ridge) will in practice have some degree of curvature (or radius). Such curvature may be beneficial, for example when cold spraying the deposition layers, as it reduces the effect of a sudden change in angle of the impinging supersonic jet on the substrate, improving the resultant quality of the initial deposition layers, e.g. reducing porosity.

Adjacent surface features are generally arranged on the substrate in sufficient proximity to beneficially disrupt stresses accumulating in the metallic structure built up on the substrate. In some embodiments, the elongated non-vertical walls of adjacent stress-disrupting surface features are spaced apart by a distance, across the base plane of the substrate, of between 3 mm and 20 mm, e.g. between 5 and 15 mm. Separation of adjacent features greater than 20 mm may be also suitable in embodiments where a lower risk of delamination or cracking exists. In some embodiments, as already disclosed herein, surface features may be present proximate to one or more edges of the substrate, for example so that an elongated non-vertical wall of a surface feature is directly adjacent to or within 10 mm, preferably within 5 mm, of the edge(s). This may advantageously disrupt the planarity of the deposition layers close to the edges of the metallic structure where failure of the structure is most likely.

The elongated non-vertical walls of adjacent surface features, such as adjacent grooves, ridges or inclined steps, may be parallel, and optionally also uniformly spaced apart, in the plane of the substrate. In some embodiments, the uniformly spaced surface features, e.g. grooves, have a pitch of between 5 and 30 mm. Uniformity in the configurations of individual surface features and their arrangement on the surface may advantageously allow the accumulated stresses to be disrupted reliably across the width of metallic structures, including large scale structures. The elongated non-vertical walls may also be linear in the plane of the substrate, for example in cases where a raster deposition pattern is used. However, it will be understood than non-uniform and non-linear surface features and walls are contemplated, and these may be desirable in some embodiments, for example where a metallic structure of complex shape is produced by non-linear or divergent deposition patterns.

The profile of the substrate surface, including the surface features, may be produced by any suitable means. Such methods may include machining the surface features into a pre-existing substrate, for example a planar substrate. Alternatively, a profiled substrate may be manufactured directly, for example by casting or moulding.

The profiled substrate may also be produced by additive manufacturing, such as cold-spray deposition, techniques. For example, a series of cold sprayed deposition layers of a suitable material may be deposited on a planar substrate to build up the surface features. In some such embodiments, the cold-sprayed material used to profile the substrate is different from the metallic material subsequently used to produce the metallic structure. In particular, it may be selected for optimum compatibility and adhesion to the starting substrate. Thus, for example, a metal such as copper may be cold-sprayed onto a planar aluminium substrate to form strongly adhered protruding surface features, e.g. V-shaped ridges, or a surface layer with recessed surface features, e.g. V-shaped grooves or inclined-step corrugations. This profiled substrate, comprising both copper and aluminium, may then be used as the deposition-receptive substrate in the process of the invention, for example to produce a high-stress metallic structure with a thermally dissimilar metal such as Invar 36. Alternatively, the cold-sprayed material used to profile the substrate is the same as the metallic material subsequently used to produce the metallic structure via sequential deposition layers, and indeed the surface features initially produced as part of the substrate may ultimately form an integral part of the intended article of manufacture.

### Metallic Deposition by Additive Manufacturing

The process comprises depositing metallic material on the profiled surface of the substrate by an additive manufacturing technique which builds up a metallic structure via successive deposition layers. The first deposition layer conforms to the profiled surface of the substrate, and each successive deposition layer conforms sufficiently to the profile of the preceding deposition layer to propagate a surface profile corresponding to the profiled surface of the substrate through all or part of the thickness of the metallic structure. As a consequence, many or all of the deposition layers are non-planar. Therefore, an important requirement of the additive manufacturing technique is that it is capable of producing non-planar deposition layers which conform closely to a profiled deposition surface.

A range of additive manufacturing techniques are capable of such a mode of operation, and it is envisaged that the methods disclosed herein can be used generally to address the issues of delamination, cracking or substrate distortion which arise when metallic structures of significant thickness are deposited with such additive manufacturing techniques. By contrast, some other additive manufacturing techniques, including many powder bed techniques, inherently build up the additively manufactured structure via a series of planar deposition layers, or “slices”. Techniques of this nature, which cannot produce deposition layers which conform to a non-planar substrate, are not contemplated for use in the methods disclosed herein.

In suitable additive manufacturing techniques, the metallic material is generally deposited by (i) selectively directing metallic particles or molten metal droplets from a metal applicator onto the substrate or preceding deposition layer; or (ii) selectively irradiating (and thus melting or sintering) metallic powder on the substrate or the preceding deposition layer with an energetic beam, such as a laser. Examples of (i) include cold spray deposition and wire arc additive manufacturing techniques. Examples of (ii) include direct metal laser melting (DMLM) and electron-beam melting (EBM).

Cold spray deposition, also known as cold gas dynamic spraying, is a known process for producing metallic coatings and structures on surfaces. In general terms, the process involves feeding metallic and/or non-metallic particles into a high-pressure gas flow stream which is then passed through a converging/diverging nozzle that causes the gas stream to be accelerated to supersonic velocities, or feeding particles into a supersonic gas stream after the nozzle throat. The particles are then directed at a surface to be deposited.

The process is carried out at relatively low temperatures, below the melting point of the substrate and the particles to be deposited, with a cohesive deposit being formed as a result of particle impingement on the substrate surface. The low temperature process allows thermodynamic, thermal and/or chemical effects, on the substrate and the particles making up the deposited structure, to be reduced or avoided. This means that the original structure and properties of the particles can be preserved without phase transformations or the like that might otherwise be associated with high temperature coating processes such as plasma, HVOF, arc, gas-flame spraying or other thermal spraying processes. The underlying principles, apparatus and methodology of cold spraying are described, for example, in U.S. Pat. No. 5,302,414 the contents of which should be understood to be incorporated into this specification by this reference.

Cold spray apparatus used for implementation of a method of the present invention is likely to be of conventional form and such equipment is commercially available or individually built. It should be appreciated that the present invention is not limited to one or a certain type of cold spray system or equipment, and can be implemented using a wide variety of cold spray systems and equipment.

The operating parameters for the cold spraying process may be manipulated in order to achieve a metallic structure that has desirable characteristics (density, surface finish etc). Thus, parameters such as temperature, pressure, stand-off distance (the distance between the cold spraying nozzle and the starter substrate surface to be coated), powder feed rate and relative movement of the starter substrate and the cold spraying nozzle, may be adjusted as necessary. Generally, the smaller the particle size and distribution, the denser the layer formed on the surface of the substrate. It may be appropriate to adapt the cold spraying equipment used in order to allow for higher pressures and higher temperatures to be used in order to achieve higher particle velocity and more dense microstructures, or to allow for pre-heating the particles.

In use, the spray stream from the nozzle is preferably directed onto the substrate at an approximately constant angle, typically substantially normal to the plane of the substrate. Thus, the deposition layers are generally not conformed to the surface profile of the deposition surface (whether the substrate surface or a preceding deposition layer) by varying the spray direction. The profiled surface may thus be configured to allow the first deposition layer to conform to the profiled surface, including the elongated non-vertical walls, without variation of the spray angle relative to the surface.

Wire arc additive manufacturing (WAAM) is another known process for producing three-dimensional metallic structures. In this process, a metal wire used as the feedstock is melted with an electric arc heat source. A robotic arm is used to selectively direct the molten metal droplets onto the substrate to form a desired configuration. The resolution of WAAM deposition is typically in the order of 1 mm, which is sufficiently accurate to build up metallic structures as near net shapes to be finished into an ultimate metallic part.

As implemented according to embodiments of the present disclosure, the molten droplets may form a melt pool which is moved along a programmed deposition path, typically in a raster pattern, that traverses the profiled surface of the substrate. Thus, the WAAM technique is used to form a first deposition layer which conforms to the profile of the substrate. Successive deposition layers are then deposited to produce a metallic structure comprising many deposition layers, with the surface profile of the substrate propagating through the thickness of the structure. The inventors have observed that very significant stresses accumulate in a mild steel structure produced by depositing planar deposition layers by WAAM, to the extent that the (planar) substrate buckled in the deposition direction by the stresses that accumulated in the steel deposit. It is envisaged that these issues can be addressed by providing the substrate with a profiled surface comprising a plurality of recessed and/or protruding surface features, as disclosed herein, to disrupt the planarity of the WAAM deposition layers.

Direct metal laser melting (DMLM), also known as selective laser melting (SLM), is another known process for producing three-dimensional metallic structures. In this process, metallic powder is selectively melted on, and thereafter fused to, the substrate by moving a high powered laser along a programmed deposition path, typically in a raster pattern, across the surface of the substrate. DMLM can thus be used to form a first deposition layer on a substrate with successive deposition layers then deposited on top to produce a metallic structure comprising many deposition layers. As implemented according to the present disclosure, the metallic powder feedstock may be selectively directed, via a stream of gas, into the laser path where it melts into a melt pool which is moved along the programmed deposition path as it traverses the profiled surface of the substrate. Thus, DMLM produces a first deposition layer which conforms to the profile of the substrate. Subsequent deposition layers conform to the profile of the preceding surface so that a surface profile is propagated through the thickness of the resultant metallic structure.

Electron-beam melting (EBM) may also be used as the additive manufacturing technique in the methods disclosed herein, operating in similar manner to DMLM but using an electron beam as the energetic beam.

For these and similar additive manufacturing techniques, the metallic material may be deposited by moving the metal applicator or energetic beam, relative to the profiled surface, in a direction which is substantially orthogonal to the elongated non-vertical walls of the recessed or protruding surface features. It has been observed for both cold spray and WAAM deposition that the stresses accumulate to the greatest degree in the deposition direction. Therefore, the greatest benefit in disrupting these stresses may be obtained by selecting a deposition direction, for example the direction of the back-and forth linear sweeps of a raster pattern, which is oriented substantially orthogonally)(90°±15° to the elongation of the surface features.

For the specific case of cold spray deposition, the metallic material may be deposited by moving the cold spray applicator relative to the substrate, for example by scanning the spray stream in a linear spray path across the substrate. Typically, the relative movement between cold spray applicator and substrate is thus created without rotating the substrate. The deposition layers may be deposited in a single deposition direction, for example by linearly scanning the cold sprayed stream of particles back and forth across the substrate (a raster pattern). Such an approach is particularly favoured for the production of large-scale metallic structures.

While the present process is considered particularly useful for building structures on non-rotating substrates, it is also envisaged that the methods disclosed herein can supplement the advantages of manufacturing round metallic structures on a rotating substrate as disclosed in WO2015/157816. Surface features capable of propagating a surface profile may thus be formed on the starter substrate, for example V-shaped grooves arranged in radial orientation to the axis of rotation. The metallic structure is then built up by cold spray deposition on the rotating profiled substrate, and a surface profile corresponding to the profiled starter substrate propagates through the metallic structure in the axial direction.

### Metallic Material

The deposited material may comprise any suitable metallic material, including metals and metal alloys. In some embodiments, the metallic material comprises at least one of nickel, iron, titanium, copper, aluminium, tantalum, magnesium or an alloy thereof.

One particular class of metallic materials of interest is low thermal expansion alloys, for example nickel alloys or iron-based nickel-containing alloys, e.g. a nickel-iron alloy containing from 30-50 wt. % nickel, such as from 36-42 wt. % nickel. One such material is Invar 36, a 36% nickel-64% iron alloy having a rate of thermal expansion approximately one-tenth that of carbon steel at temperatures up to 204° C. Due to its low thermal expansion co-efficient, Invar 36 and similar materials are of great interest in the fabrication of metallic parts for applications where expansion during thermal cycling should be minimised, for example to produce faceplates of lay up tools for moulding and curing fibre composites.

The invention is considered particularly useful for producing metallic structures on substrates where the respective materials have different thermal properties, in particular where the substrate and the deposited (e.g. cold sprayed) metallic material have different coefficients of thermal expansion. For example, it may be desirable to produce a low thermal expansion metallic structure, e.g. of Invar 36 which has a thermal expansion coefficient of 1.2×10⁻⁶ mm/(mm.° C.), on a high thermal expansion material substrate, e.g. of aluminium which has a thermal expansion coefficient of 23×10⁻⁶ mm/(mm.° C.). The invention has been shown to reduce the risk of delamination in such scenarios. In some embodiments, therefore, the substrate and the metallic material have coefficients of thermal expansion which differ (substractively) by more than 5×10⁻⁶ mm/(mm.° C.), or by more than 10×10⁻⁶ mm/(mm.° C.), or by more than 15×10⁻⁶ mm/(mm.° C.).

In some embodiments, the deposited material comprises, in addition to metallic material, a non-metallic material such as a ceramic or glass. In other embodiments, the cold sprayed material comprises a mixture of different metallic materials. For example, a blend of two or more different powders, or composite particles (particles consisting of more than one material) could be used as feedstock for cold spray deposition. Thus, a metal composite structure can be produced by the methods disclosed herein.

In some embodiments, the composition of the deposited material is varied through the thickness of the metallic structure to be produced. This may provide flexibility in terms of product characteristics. For example, a metallic structure that has different weld characteristics at opposing sides may be produced by varying the composition. Alternatively, if a variation in the metallic structure properties (for example, coefficient of thermal expansion) is desired through the thickness, the composition may be varied accordingly. The metallic structure may comprise discrete thicknesses of different materials or the composition may be varied gradually through the thickness.

If a metallic structure is to be manufactured from multiple materials, then the compatibility of the different materials must be considered. Should two or more of the proposed materials be incompatible in some way (for example coherence/bonding), it may be necessary to separate the incompatible materials by one or more regions of mutually compatible material(s). Alternatively, the structure could be manufactured such that there is a gradual change in composition from one material to the next to ease any incompatibility problems between the materials used.

For cold spray embodiments, any suitable particle/powder can be used in the process disclosed herein. The powder/particles used, and properties thereof will typically be selected to meet the desired properties, composition and/or economics for a particular metallic structure product. Typically, the size of the particles applied by cold spraying is from 5 to 45 microns with an average particle size of 15 to 30 microns. However, it should be appreciated that the particle size may vary depending on the source and specification of the powder used. Similarly, larger particles could also be used in some applications, for example particle sizes up to around 150 microns. A person skilled in the art will be able to determine the optimum particle size or particle size distribution to use based on the morphology of the powder and characteristics of the metallic structure that is to be formed. For example, the average size of the particles that are cold sprayed is likely to influence the density of the resultant deposit, and thus the density of the metallic structure that is formed. The sprayed particles may be spherical, non-spherical but regular shaped or irregularly shaped, but spherical particles are preferred. Particulate metallic materials suitable for use in embodiments of the present invention are commercially available.

### Metallic Structure

In the process disclosed herein, successive deposition layers of metallic material are deposited by an additive manufacturing technique, such as cold spray deposition, to build up a metallic structure on the substrate. As used herein, a metallic structure comprises one or more metals or metal alloys, but may also comprise non-metals such as ceramics or glass, e.g. in a metal matrix composite material. It will also be appreciated that a metallic structure generally has significant bulk (or thickness) and/or strength, and is thus distinguished from metal deposition coatings which are applied to vary the surface characteristics of an existing structure. As coatings are thin layers, for example less than 3 mm, the accumulated stresses in metal deposition coatings, such as cold sprayed coatings, are generally insignificant so that the risk of stress-induced delamination and cracking is low. By contrast, in embodiments of the invention, the metallic structure may have a thickness of at least 3.5 mm, or at least 5 mm, or at least 7 mm, or at least 10 mm, or at least 15 mm in at least part (optionally all) of the metallic structure through which the surface profile is propagated.

The present invention is considered particularly useful in the production of large-scale articles, preforms and components (although it is not to be so limited). In some embodiments, the metallic substrate has at least one dimension, in (along) the plane of the substrate on which is produced, of greater 100 mm, or 500 mm, or 1000 mm. In some such embodiments, the dimension of greater than 100 mm, 500 mm or 1000 mm is in the deposition direction, for example that of a raster pattern. It has been shown that very significant stresses are built up within such metallic structures, which may be usefully addressed by embodiments of the invention.

The metallic structure preferably has at least 80% density, preferably at least 90% density, and more preferably at least 95% density as produced. The density of the structure as produced is material and technique dependent. For cold sprayed structures, for example, the density may be affected by the cold spray conditions and particles. Preferably, the deposited material is of uniform density and free from defects, connected micro-voids (leakage) and the like, since the presence of such can be detrimental to the quality of the resultant metallic structure. One advantage of cold sprayed metallic structures is that a substantially uniform microstructure can be produced throughout, without macro-segregation and other melt-related defects found in ingots because the constituting powder particles are not melted in the cold spray process. In some embodiments, however, the metallic structure includes pores which are generally on the same scale as the sprayed particles. The pores are preferably of uniform concentration throughout the metallic structure.

It may be desirable to remove the metallic structure from the substrate once it is formed, particularly where the substrate does not have the same material composition as the metallic structure. The process of the present invention can therefore further comprise the step of removing the metallic structure from the substrate. This typically occurs at or after the conclusion of the metal deposition process. Separation of the metallic structure from the substrate may be achieved by any suitable means, including mechanical means such as cutting, cleaving, breaking, fracturing, shearing, breaking or the like, or by other means including dissolving, melting, evaporating or the like of the substrate.

It may be desirable to finish the metallic structure after its production by cold spray, for example by grinding and/or polishing. It is common in additive manufacturing to produce a metallic structure as a near net shape, thus requiring only a minor degree of machining to produce the ultimate configuration of an article or component. The metallic structure may also be subjected to post-processing steps such as heat treatment.

The finished form of the metallic structures may be objects or components used in a variety of industrial applications, including in aerospace, vehicle manufacture, marine, mining, and construction industries. One exemplary application is in manufacture of the faceplates of lay up tools for moulding and curing fibre composites, e.g. in the aerospace industry.

### Extending the Metallic Structure Thickness

The present invention further provides the opportunity to produce metallic structures of very significant thickness by repetition of the disclosed process steps. Thus, the process may further include a step of forming a plurality of recessed and/or protruding surface features in a top surface of the additively manufactured metallic structure, for example by machining or by additive manufacturing methods. The top surface features, for example V-shaped grooves, have elongated non-vertical walls which may optionally also have a depth of at least 0.5 mm, at least 1 mm, at least 1.5 mm, or at least 2 mm. Metallic material is then deposited on the top surface of the metallic structure by an additive manufacturing method, for example cold spray deposition, to produce a further deposition layer which conforms to the profiled top surface including the elongated non-vertical walls. Successive deposition layers of the metallic material are then deposited on the further deposition layer by the additive manufacturing method to extend the thickness of the metallic structure from the initial (first) thickness to an extended (second) thickness.

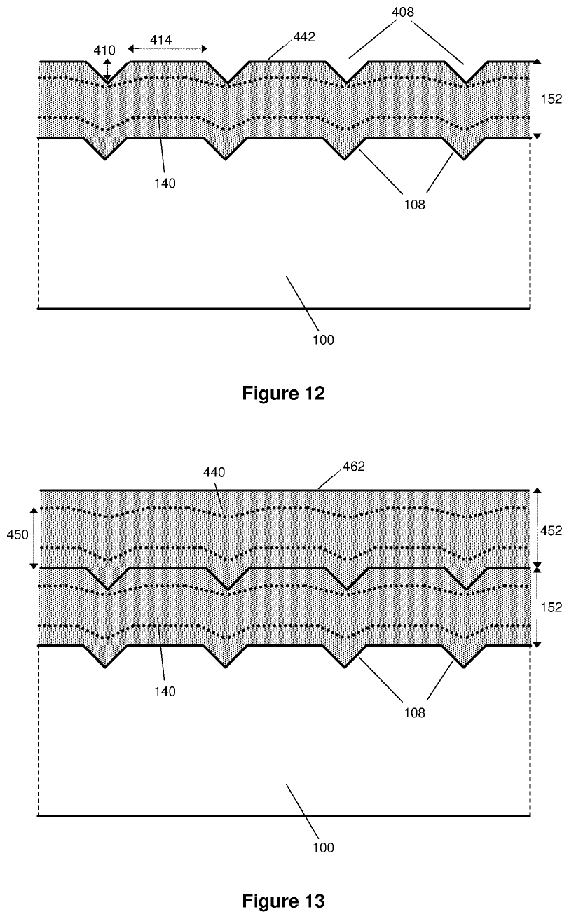

Such an embodiment will now be described with reference to FIGS. 12 and 13. Flat-topped metallic structure 140, as described herein with reference to FIG. 9, is used as the starting point. As seen in FIG. 12, V-shaped grooves 408 are produced in top surface 142 by machining. Grooves 408 have a depth 410 of at least 0.5 mm, such as between 1 mm and 3 mm, and a groove spacing 414 which may be between 3 mm and 20 mm, for example between 5 and 15 mm. Top surface grooves 408 may thus have a similar configuration to substrate grooves 108, although this is not essential. Indeed, other top-surface features including inclined steps or even V-shaped ridges could be produced by machining or other methods. In a further variation, a metallic structure retaining a top-surface profile propagated from the substrate, for example as seen in FIG. 8, may be used as the starting point. In this case, the new surface features produced on the top surface will generally have greater depth and sharper resolution than the partially flattened starting profile.

As seen in FIG. 13, extended metallic structure 440 is then built up by depositing a series of successive deposition layers on top surface 142. The deposition layers may be deposited in a single deposition direction, e.g. in a raster pattern, which is preferably substantially orthogonal to the elongated non-vertical walls of grooves 408. Each successive deposition layer conforms sufficiently to the profile of its preceding deposition layer to propagate a surface profile corresponding to the profiled surface of the substrate through a substantial thickness of extended metallic structure 440. In the depicted embodiment, cold spray deposition is continued to a thickness at which top surface 462 again becomes substantially flat. In accordance with the principles disclosed herein, however, a surface profile corresponding to grooves 408 of surface 442 is propagated through a thickness 450 which forms a substantial proportion of the total thickness 452 of extended metallic structure 440, for example at least 50%, at least 60%, at least 70%, at least 80% or at least 90%.

Metallic structures 140 and 440 together form a single extended metallic structure with a total extended thickness which equals the sum of thicknesses 152 and 452. Despite the very substantial total thickness, the risk of delamination and/or cracking is reduced because of the non-planarity of a high proportion of the individual deposition layers. Advantageously, the method of the invention may thus be used to produce metallic structures of any desired thickness by two or more process repetition cycles.

### Metallic Structure Produced by Cold Spray Deposition on a Substrate

The present invention further relates to a metallic structure produced by additive manufacturing on a substrate. The substrate used as a template for the metallic structure comprises a profiled surface having a plurality of recessed and/or protruding surface features with elongated non-vertical walls and a depth of at least 0.5 mm relative to a base plane of the substrate. The metallic structure comprises a first deposition layer comprising metallic material which was deposited on the substrate so that the first deposition layer conformed to the profiled surface of the substrate including the elongated non-vertical walls. The metallic structure further comprises successive deposition layers comprising the metallic material which were deposited on the first deposition layer. Each successive deposition layer conformed sufficiently to the profile of its preceding deposition layer so that a surface profile corresponding to the profiled surface of the substrate is propagated through the entire thickness of the metallic structure or a substantial portion thereof.

It will be appreciated that the metallic structure is generally as disclosed herein in the context of the process of the invention.

In some embodiments, the metallic structure remains on the substrate. In other embodiments, the metallic structure is separated from the substrate. In at least some embodiments where the metallic structure is separated from the templating substrate, the configuration of the substrate on which the metallic structure was produced, and its effect on the configuration of the first and successive cold sprayed deposition layers, may be inferred from the macro- and/or microstructure of the metallic structure, for example by visual analysis or microstructural characterisation techniques such as metallography and X-ray analysis.

### EXAMPLES

The present invention is described with reference to the following examples. It is to be understood that the examples are illustrative of and not limiting to the invention described herein.

### Example 1 (Comparative)

A cold spray system comprising a cold spray gun with nozzle mounted on a robotic arm was operated under the conditions shown in the Table below:

| Cold spray system | Impact Innovations |
|---|---|
| Cold spray nozzle | Out1 |
| Temperature (° C.) | 850 |
| Pressure (bar) | 50 |
| Stand-off distance (mm) | 40 |
| Robot traverse speed (mm/s) | 200 |
| Spray angle | Normal to the substrate base plane |
| Feedstock powder | Invar 36, 20 micron average particle size |
| Powder feed rate (kg/h) | 1.5 |

A grit-blasted planar aluminium substrate (aluminium 5083) with a horizontal width of 100 mm, height of 300 mm and thickness of 16 mm was vertically mounted, and an Invar 36 structure with dimensions of 100 mm×100 mm was built on the substrate with the cold spray system, using a raster deposition pattern. Thus, the nozzle was moved along a linear horizontal spray path back and forth across the full width of the substrate, displacing the nozzle vertically after each pass, to produce a first deposition layer with a horizontal width of 100 mm (equal to the substrate width) and a vertical height of 100 mm. After the first deposition layer was completed, the Invar block structure was built up on this initial square footprint by depositing successive layers of sprayed Invar on the first deposition layer with the same raster deposition pattern until a thickness of about 10 mm was achieved.

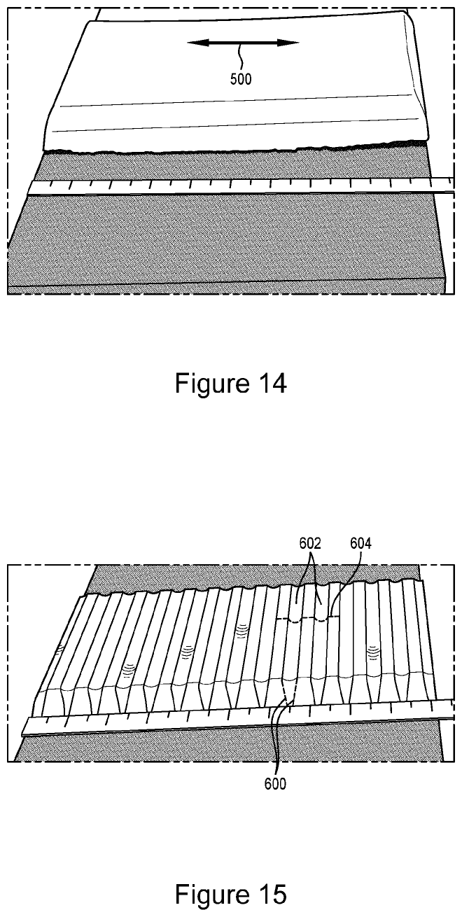

It was observed at this point that the Invar 36 block had delaminated from the aluminium substrate. The Invar 36 structure on the aluminium substrate is shown in FIG. 14, with arrow 500 indicating the raster direction. The greater displacement of the delaminated structure at the edges of the substrate indicates that the distortion of the Invar block occurred mainly in the direction of deposition.

Aluminium and Invar 36 are metals with very different thermal properties. The selection of these two materials for the present test work thus demonstrates the difficulties in producing large-scale structures with significant thickness by cold-spray and provides a demanding test at which significant improvements in substrate-deposit adhesion and deposit cohesion are expected to be generally applicable across a wide range of substrates and cold-sprayed materials.

### Example 2

Fifteen parallel and uniformly spaced V-shaped grooves were machined into a planar aluminium substrate (aluminium 5083) with a horizontal width of 100 mm, height of 300 mm and thickness of 16 mm, and grit-blasted prior to cold spray deposition. The machined substrate had the configuration depicted in FIGS. 4 and 5, where groove length 106 is 110 mm, groove depth 110 is 1 mm, groove width 124 is 2 mm, groove angle 122 is 90°, and groove spacing 114 is 5 mm. The substrate thus has a profiled surface comprising a plurality of recessed grooves 108 with a depth of 1 mm and side walls 118 which are elongated in the plane of the substrate and inclined at an angle 120 of 135° relative to base plane 112 of the substrate.

The profiled substrate was mounted vertically, and an Invar structure was built on the profiled substrate using the same cold spray equipment, raster deposition pattern and conditions as used in Example 1. The raster deposition was in the direction of arrow 132 in FIG. 4, so that the horizontal spray path traversed across the grooves in a direction orthogonal to the elongation axis of the groove walls. The first deposition layer was formed on the profiled surface with a horizontal width of 100 mm (equal to the substrate width) and a vertical height of 100 mm, with the grooves thus extending beyond the deposition layer at both the top and the bottom. The first deposition layer was a continuous layer over the substrate surface and conformed to the profiled surface topology including the inclined groove walls. An Invar block structure was then built up on the initial square footprint by depositing successive layers of sprayed Invar 36 on the first deposition layer with the same raster deposition pattern until a thickness of about 4 mm was achieved.

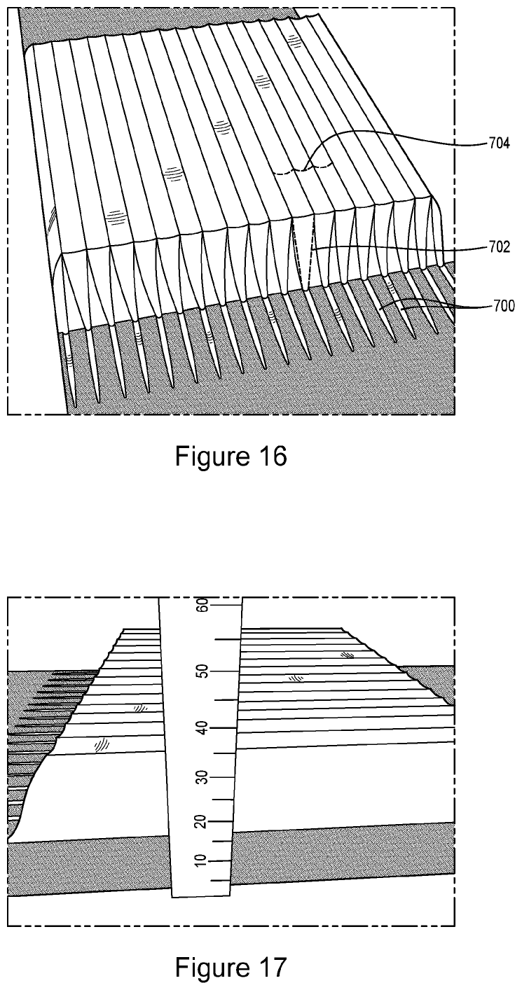

The Invar 36 block on the profiled substrate is depicted in FIG. 15. The structure remained fully adhered to the substrate and no cracks were evident within the deposited Invar 36. It is evident that a surface profile corresponding to that of the profiled substrate surface had propagated through the entire thickness of the deposit. This is visually evident from a side view of the block: see lines 600 provided as a visual guide. On top of the block, the propagated surface profile comprises elongated surface grooves 602, corresponding to the substrate grooves but having a greater width and shallower depth due to the “flattening out” or loss of resolution with each successive sprayed deposition layer: see lines 604 provided as a visual guide.

Another Invar 36 block was produced by the same methodology on an identical profiled substrate, but this time to a thickness of about 12 mm. A surface profile corresponding to the initial substrate grooves remained visible on the top surface, despite further flattening as compared to that seen in FIG. 15. At this greater thickness it was observed that cracks had formed at the substrate-Invar interface and at the side edges of the Invar block. However, the block did not delaminate entirely from the substrate and less distortion was evident in the raster direction when compared to the block produced on a flat substrate in Example 1.

### Example 3

A profiled aluminium substrate was prepared as described in Example 2, except that eighteen V-shaped grooves with a groove angle of 60° (instead of 90°) were produced by machining. The groove walls were thus inclined at an angle of 120° relative to the base plane of the substrate. The groove spacing remained 5 mm and the groove depth 1 mm, so that the groove width was about 1.2 mm.

An Invar 36 structure was then produced on the profiled substrate by the method of Example 2 to a thickness of about 15 mm. The resultant structure is depicted in FIGS. 16 and 17. A surface profile corresponding to the initial substrate grooves 700 remained visible on the top surface, despite substantial flattening after such a great thickness: see lines 702 provided as a visual guide in FIG. 16. After the addition of so many deposition layers, the elongated surface depressions corresponding to the substrate grooves had widened to the point that the intermediate surface portions were narrow ridges rather than a planar surface area: see guide lines 704. The Invar deposit did not delaminate and there was good adhesion of Invar structure 708 to aluminium substrate 710 across the full substrate width, despite a few very fine cracks: see FIG. 17.

### Example 4

A profiled aluminium substrate was prepared as described in Example 2, except that eight grooves with a length of 150 mm, a groove depth (110 in FIG. 5) of 2 mm and a groove spacing (114 in FIG. 5) of 10 mm were produced by machining. The groove angle was again 90°, so that the groove width was 4 mm and the groove walls were inclined at an angle of 135° relative to the base plane of the substrate.

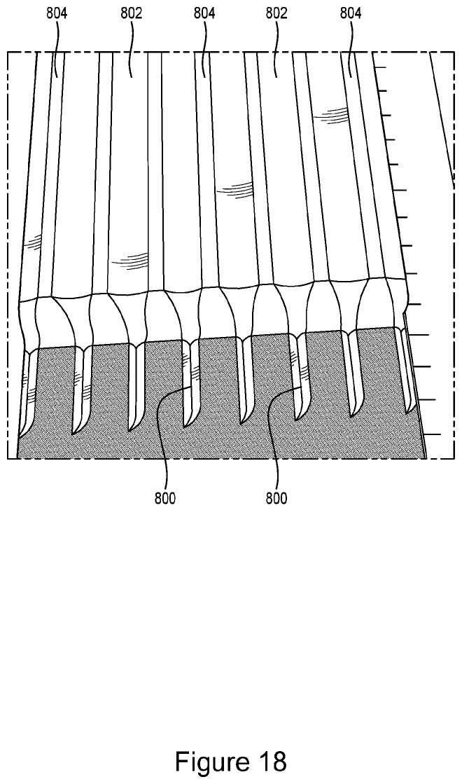

An Invar 36 structure was then produced on the profiled substrate by the method of Example 2 to a thickness about 12 mm. The resultant structure is depicted in FIG. 18. A surface profile, comprising well-defined elongated grooves 802 corresponding to but wider than the initial substrate grooves 800 and separated by planar intermediate surface areas 804, was evident on the top surface of the Invar block. No delamination or cracking was evident at the substrate-Invar interface or within the Invar deposit. Compared with Example 2, the greater depth of the substrate grooves (2 mm vs 1 mm) apparently improved the adhesion and cohesion of the deposited structure. It is proposed that this is due to the greater disruption of the internal stresses by the non-planarity of the deposition layers, both adjacent the substrate and through the thickness of the structure due to the propagation of the surface profile.

### Example 5 (Comparative)

A cold spray system comprising a cold spray gun with nozzle mounted on a robotic arm was operated under the conditions shown in the Table below:

| Cold spray system | Impact Innovations |
|---|---|
| Cold spray nozzle | Out1 |
| Temperature (° C.) | 700 |
| Pressure (bar) | 50 |
| Stand-off distance (mm) | 25 |
| Robot traverse speed (mm/s) | 200 |
| Spray angle | Normal to the substrate base plane |
| Feedstock powder | Commercially Pure Titanium (CP Ti), 25 |
| | micron average particle size |
| Powder feed rate (kg/h) | 1.5 |

A mild steel planar substrate with a horizontal width of 50 mm and height of 50 mm was vertically mounted, and a CP Ti structure covering the substrate surface was built on the substrate with the cold spray system, using a raster deposition pattern. Thus, the nozzle was moved along a linear horizontal spray path back and forth across the full width of the substrate, displacing the nozzle vertically after each pass. The width of each pass was about 3 mm, and the nozzle was displaced vertically by 1.5 mm for each sweep to ensure overlap between the lines. After the first deposition layer was completed, the CP Ti block structure was built up on this initial square footprint by depositing successive layers of sprayed CP Ti on the first deposition layer with the same raster deposition pattern to increase the thickness.

Up to a thickness of about 2 mm, the CP Ti metallic structure adhered well to the substrate. However, the deposit delaminated from the substrate once a thickness of about 3 mm was reached.

### Example 6

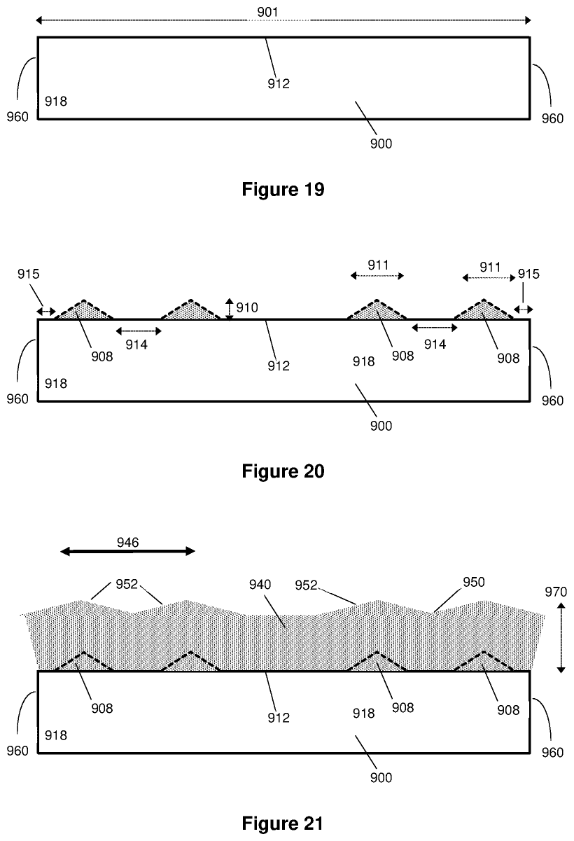

Example 6 is described with reference to FIGS. 19-21. As seen in the top view of FIG. 19, planar mild steel substrate 900 with a horizontal width (arrow 901) of 50 mm and height of 50 mm was vertically mounted. Using the cold spray apparatus and methodology of Example 5, four approximately V-shaped ridges 908 were then cold sprayed onto the substrate (FIG. 20). Ridges 908, which were vertically oriented and extended the full height of the substrate, had a width (arrow 911) of about 3 mm and a depth (i.e. protrusion distance from base plane 912 of the substrate, indicated by arrow 910) of about 0.5 mm. The outermost ridges 908 were spaced apart from edges 960 of the substrate by a distance (arrow 915) of about 2 mm, and the two ridges on each side of the substrate were spaced apart by about 10 mm (arrow 914). The ridges were placed in this manner, close to the edges of the substrate, as this is where delamination had occurred in Example 5. It is believed that the greatest thermal gradient during the cold spray deposition is present at the substrate edges.

A CP Ti structure 940 was then built on modified substrate 900 with the cold spray system, using a raster deposition pattern. Thus, the nozzle was moved along a linear horizontal spray path, indicated by arrow 946, back and forth across the full width of the substrate, displacing the nozzle vertically after each pass. Each sweep of the spray path traversed ridges 908 orthogonally to their vertical axis of elongation. The width of each pass was about 3 mm, and the nozzle was displaced vertically by 1.5 mm for each sweep to ensure overlap between the lines. The first deposition layer deposited in this way was a continuous layer which conformed to the profiled surface of substrate 900, including ridges 908 and the exposed steel base plane portions 912 of the substrate. After the first deposition layer was completed, the CP Ti block structure 940 was built up on this initial square footprint by depositing successive layers of sprayed CP Ti on the first deposition layer with the same raster deposition pattern to increase the thickness. As seen in FIG. 21, a surface profile 950 corresponding to the initial profiled surface (formed by ridges 908 on substrate 900), of the substrate was propagated through the thickness of the deposit, although the resolution was gradually lost as the thickness increased (rounded ridges 952 were evident).

Metallic structures 940 were built up in this manner to a thickness (arrow 970) of 5 mm and 7 mm without delamination or cracking of the deposit. Again, it is proposed that the disruption of the planarity of the deposition layers as they curve around the grooved formations in the substrate is responsible for the improved stability of the deposit.

To achieve even greater thicknesses, the same procedure was used to produce a metallic structure 940 with a thickness of 5 mm. At this point, new V-shaped ridges having a similar configuration to ridges 908 were selectively cold sprayed onto the metallic structure, thus restoring the “sharpness” of its surface profile. Continued cold spraying of further continuous deposition layers via the same raster deposition pattern was thus able to extend the thickness of the metallic structure to greater than 10 mm without delamination or cracking of the deposit.

Those skilled in the art will appreciate that the invention described herein is susceptible to variations and modifications other than those specifically described. It is understood that the invention includes all such variations and modifications which fall within the spirit and scope of the present invention.

1. A process for producing a metallic structure by additive manufacturing, the process comprising:
providing a deposition-receptive substrate comprising a profiled surface, the profiled surface comprising a plurality of recessed and/or protruding surface features having elongated non-vertical walls and a depth of at least 0.5 mm relative to a base plane of the substrate;
depositing metallic material on the substrate by an additive manufacturing technique to produce a first deposition layer which conforms to the profiled surface including the elongated non-vertical walls; and
depositing successive deposition layers of the metallic material on the first deposition layer by the additive manufacturing technique to build up a metallic structure having a first thickness on the substrate,
wherein each successive deposition layer conforms sufficiently to the profile of its preceding deposition layer to propagate a surface profile corresponding to the profiled surface of the substrate through the first thickness or a substantial portion thereof.

2. The process according to claim 1, wherein the metallic material is deposited by (i) selectively directing metallic particles or molten metal droplets from a metal applicator onto the substrate or the preceding deposition layer; or (ii) selectively irradiating metallic powder on the substrate or the preceding deposition layer with an energetic beam.

3. The process according to claim 2, wherein the metallic material is deposited by moving the metal applicator or energetic beam, relative to the profiled surface, in a direction which is substantially orthogonal to the elongated non-vertical walls.

4. The process according to claim 3, wherein the metallic material is deposited by moving the metal applicator or energetic beam, relative to the profiled surface, in a raster pattern across the substrate.

5. The process according to claim 1, wherein the additive manufacturing technique is selected from the group consisting of cold spray deposition, direct metal laser melting (DMLM) and wire arc additive manufacturing (WAAM).

6. The process according to claim 1, wherein the additive manufacturing technique is cold spray deposition.

7. The process according to claim 1, wherein the surface features have a depth of at least 1.5 mm relative to the base plane of the substrate.

8. The process according to claim 1, wherein the surface profile corresponding to the profiled surface of the substrate is propagated through at least 5 mm of the first thickness or through the entire first thickness of the metallic structure.

9. (canceled)

10. The process according to claim 1, wherein the surface profile corresponding to the profiled surface of the substrate is propagated only partway through the first thickness of the metallic structure such that a top surface of the metallic structure, defined by an outermost deposition layer, is substantially flat.

11. The process according to claim 1, wherein the substrate and the metallic material have different coefficients of thermal expansion.

12. (canceled)

13. The process according to claim 1, wherein the elongated non-vertical walls are inclined at an angle of between 110° and 155° relative to the base plane of the substrate.

14. The process according to claim 1, wherein the surface features comprise at least one selected from grooves, ridges and inclined steps.

15. (canceled)

16. The process according to claim 1, wherein the metallic material comprises a nickel-iron alloy.

17. The process according to claim 1, wherein the first thickness is at least 5 mm.

18-19. (canceled)

20. The process according to claim 1, further comprising:
forming a plurality of recessed and/or protruding top surface features in a top surface of the metallic structure, the top surface features having elongated non-vertical walls;
depositing metallic material on the top surface of the metallic structure by an additive manufacturing method to produce a further deposition layer which conforms to the top surface including the elongated non-vertical walls; and
depositing successive deposition layers of the metallic material on the further deposition layer by the additive manufacturing method to extend the thickness of the metallic structure to a second thickness.

21. A metallic structure produced by additive manufacturing on a substrate comprising a profiled surface comprising a plurality of recessed and/or protruding surface features having elongated non-vertical walls and a depth of at least 0.5 mm relative to a base plane of the substrate, the metallic structure comprising:
a first deposition layer comprising metallic material deposited on the substrate, wherein the first deposition layer conforms to the profiled surface of the substrate including the elongated non-vertical walls; and
successive deposition layers comprising the metallic material deposited on the first deposition layer to form the metallic structure with a first thickness,
wherein each successive deposition layer conforms sufficiently to the profile of its preceding deposition layer to propagate a surface profile corresponding to the profiled surface of the substrate through the first thickness or a substantial portion thereof.

22. (canceled)

23. A metallic structure according to claim 21, wherein the surface features of the substrate have a depth of at least 1.5 mm relative to the base plane of the substrate.

24. The metallic structure according to claim 21, wherein the surface profile corresponding to the profiled surface of the substrate is propagated through at least 5 mm of the first thickness or through the entire first thickness of the metallic structure.

25-26. (canceled)

27. The metallic structure according to claim 21, wherein the surface features comprise at least one selected from grooves, ridges and inclined steps.

28. The metallic structure according to claim 21, wherein the metallic material comprises a nickel-iron alloy.

29-31. (canceled)
